(19) United States
(12) Patent Application Publication
(10) Pub. No.: US 2006/0107455 A1
(43) Pub. Date: May 25, 2006

(54) Air injector nozzle apparatus and methods for a tub or spa

(76) Inventor: Paul R. Bedard, Pompano Beach, FL (US)

Correspondence Address: Richard M. Saccocio, P.A., 100 Southeast 12th Street, Ft. Lauderdale, FL, 33316, US

(21) Appl. No.: 10/994,884

(22) Filed: Nov. 22, 2004

(51) Int. Cl. A61H 33/04

(52) U.S. Cl. 4/541.6

(57) ABSTRACT

A one piece air injector nozzle for a tub or spa, in a preferred embodiment, comprising an air flow tube, having straight ends, a connector plate, and an air injector tube, includes an offset of the air flow tube relative to the air injector tube. The air injector tube has an open end and a closed end with the closed end forming a portion of the connector plate. A connector member joins adjacent nozzles or connecting tubing. The inventive nozzle allows for bench assembly of an entire nozzle arrangement which is fitted to the bottom of a tub or spa, after which air hole are drilled simultaneously though the injector tub and the tub or spa, a plug is attached to the open end of the injector tube.

### BACKGROUND OF THE INVENTION

1. Field of the Invention

This invention is related in general to the field of air injector apparatus and particularly to the field air injector nozzles adapted to be applied to spas or bathtubs that include an air injection arrangement to inject pressurized air through jets or nozzles which are distributed over the interior of the tub or spa.

2. Description of the Prior Art

The prior art method and apparatus to construct a bathtub or spa having a plurality of air injection nozzles and associated tubing attached to and distributed about the underside of the tub is a very labor intensive and therefore costly procedure, (hereinafter the word “tub” will be used to identify a bathtub, spa, or any other water containment vessel that utilizes an air injection system).

The typical prior art procedure is to blow a thick layer of fiberglass and resin onto the underside of the tub. A plate having a plurality of pre-positioned holes distributed over the length and width of the plate is placed on the laid layer of fiberglass.

A second thick layer of fiberglass and resin is then applied to the tub including the plate positioned thereon. The holes in the plate create depressions in the second layer of fiberglass. The tub is inverted and a second plate having a plurality of holes is positioned inside the tub; a marking instrument is inserted in the holes to mark the hole location on the inside of the tub and the second plate is removed. The markings from the holes in the second plate are aligned with the depressions created by the holes in the first plate. Holes are drilled through the tub at the hole markings. The tub is again inverted. The depressions on the bottom of the tub are machined flat and a dab of silicon rubber is applied to the holes through the depressions. One prior art injector nozzle comprises a circular plate having a small diameter tube extending from one side of the plate and a separate threaded connector. With this type of prior art nozzle, the small diameter tube is inserted into the hole in the tub with the circular plate being fitted against the machined depressions on the bottom of the tub. Another type of prior art injector nozzle does not include the small diameter tube, but includes the separate threaded connector. The air from this type of nozzle exits at the connection of the connector plate and passes through the hole in the tub. With either type of prior art nozzle, a liquid silicon rubber is then used cover the circular plate and fills the depression. Then, the separate connector member having a threaded end and a hose connection end is threaded onto the nozzle. Plastic hoses are connected to the hose connections joining the all of the nozzles and then to a manifold to which a high-pressure air connection is later made when the tub is installed. The portions of the small diameter tube of the nozzles, if this type is used, are then cut flush with the interior of the tub.

The construction and design of the prior art nozzles and connector members largely contribute to the costly and labor-intensive prior art procedure above described.

Accordingly, what is needed is a nozzle that effectively minimizes the labor involved in adapting an air injection arrangement to a tub as well as providing an improved injector nozzle. The primary objects of the present invention accomplish and fulfill these needs.

The above-stated object as well as other objects which, although no specifically stated, but are intended to be included within the scope of the present invention, are accomplished by the present invention and will become apparent from the hereinafter set forth Detailed Description of the Invention, Drawings, and the Claims appended herewith.

### SUMMARY OF THE INVENTION

The present invention accomplishes the above-stated objective as well as others, as may be determined by a fair reading and interpretation of the entire specification herein. The present invention comprises a combination air injector nozzle including a main air flow tube, and air injector flow tube, and connecting member. The connecting member is adapted to be directly attachable to as laid fiberglass on the outside bottom of a tub. The inventive nozzle provides the means to drill a hole through the tub at the exact location of the nozzles without having to use a standard or particular layout of the nozzles.

The inventive method provides for connecting one air nozzle to another using a fitting, a telescoping arrangement, or a combination of both. The inventive nozzle allows for bench assembly of a complete air injection arrangement and applying the completed assembly to a tub.

### BRIEF DESCRIPTION OF THE DRAWINGS

Various other objects, advantages, and features of the invention will become apparent to those skilled in the art from the following discussion taken in conjunction with the following drawings, in which:

FIG. 1 illustrates a perspective view of one embodiment of the inventive nozzle;

FIG. 2 is a top view of the nozzle embodiment of FIG. 1;

FIG. 3 is a cross-sectional view of the embodiment of FIG. 2 taken along the line 3-3 of FIG. 2; and a cross-sectional view of the embodiment of FIG. 10 also taken along the line 3-3 thereof with the addition of a check valve and a sealing plug (both being shown in phantom) inserted into the air injection tube of the inventive nozzle.

FIG. 4 is an underside view of the nozzle embodiment of FIG. 2;

FIG. 5 is a top view of a right-angled embodiment of the inventive nozzle;

FIG. 6 is a top view of an obtuse angled embodiment of the inventive nozzle;

FIG. 7 is a top view of another embodiment of the inventive nozzle having “T” shaped configuration;

FIG. 8 is a cross sectional view of one embodiment of the plug inserted into the air injection tube shown in FIG. 3:

FIG. 9 is a cross-sectional view of a fitting for connecting adjacent nozzles;

FIG. 10 is a cross-sectional view illustrating the use of the connecting fitting;

FIG. 11 illustrates a perspective view of another embodiment of the inventive nozzle;

FIG. 12 is a top view of the nozzle embodiment of FIG. 11;

FIG. 13 is an underside view of the nozzle embodiment of FIG. 12;

FIG. 14 is a top view of a right angled embodiment of the inventive nozzle of FIG. 12;

FIG. 15 is a top view of an obtuse angled embodiment of the inventive nozzle of FIG. 12;

FIG. 16 is a top view of a “T” shaped embodiment of the inventive nozzle of FIG. 2;

FIG. 17 is a cross-sectional view illustrating the connecting attachment of the nozzles of FIGS. 12, 14, 15, and 16;

FIG. 18 is a cross-sectional view illustrating the use of the connecting fitting f FIG. 9 as applied to one nozzle according to FIG. 2 and another nozzle according to FIG. 12;

FIG. 19 illustrates another embodiment of the present invention;

FIG. 20 illustrates yet another embodiment of the present invention; and

FIG. 21 is a schematic rendering of an arbitrary arrangement of nozzles attached to the bottom of a tub as the inventive nozzles might be used in practice.

### DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

Reference is now made to the drawings, wherein like characteristics and features of the present invention shown in the various figures are designated by the same reference numerals. The scale of each drawing may or may not be the same.

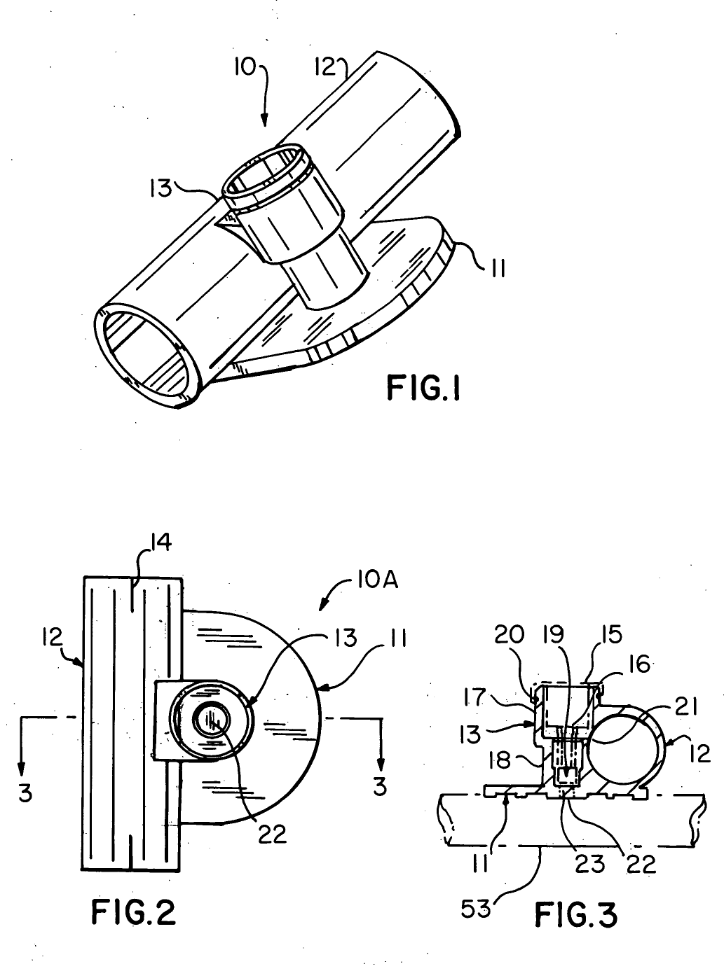

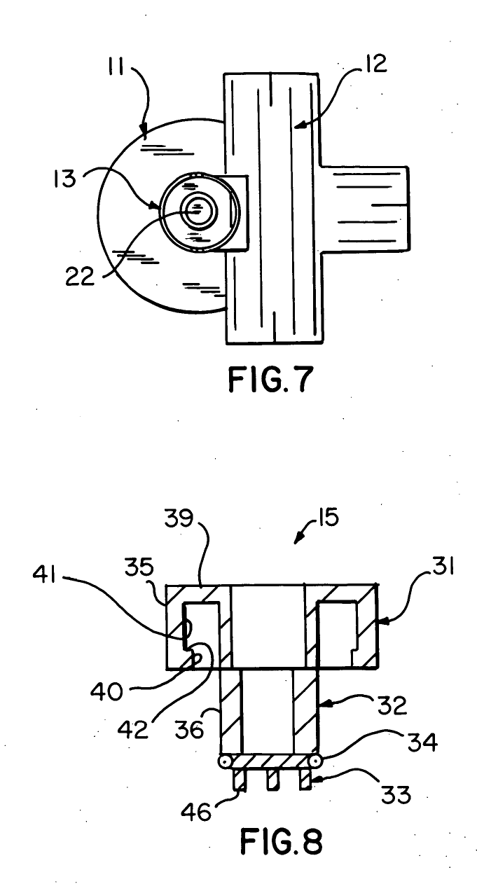

Reference is now made to FIG. 1, which is a perspective view of one embodiment 10A of the inventive nozzle 10 and to FIG. 2 which is a top view of the embodiment of the inventive air nozzle 10A of FIG. 1. The basic elements of the nozzle 10A include a base or connector plate 11, a main air flow tube 12 and an air injection tube 13. The main air flow tube 12 comprises a cylindrical tube that extends in two or more directions and outwardly from the base plate 11. The internal diameter of the air flow tube 12 is appropriately sized to permit a sufficient volume of airflow through one or more injector nozzles 10 connected in series or parallel, as is well known in the art. FIG. 5 illustrates an embodiment 10B of the inventive nozzle 10 having the main air flow tube 12 configured to have an “L” shape for such use as an outside corner of an array of nozzles 10 arranged perpendicular to each other. FIG. 6 illustrates yet another nozzle embodiment 10C with the configuration of the main air flow tube 12 having an angled shape with an included angle 25, such as one hundred and thirty-five degrees. The nozzle embodiment 10C is for such use as a corner where greater than ninety degrees is desired. Of course, the included angle 25 can be of any desired size. FIG. 7 illustrates an embodiment 10D of the inventive nozzle 10 having the main air flow 12 configured to have a “T” shaped configuration so as to provide an end nozzle connecting with the air pump and branch off to two lines of connected nozzles 10, or to allow three separate lines of connected nozzles. It is to be noted that the open and opposite ends of the flow tube 12 in the embodiments 10A, 10B, 10C, and 10D are provided with the same sized inner and outer diameters. Because the diameters are the same, the nozzle embodiments of nozzle 10 can be rotated to face in opposite directions and still allow nozzle to nozzle connections to be made as further described below. Thus, a combination of only four different shapes of the inventive nozzle 10, i.e. 10A, 10B, 10C and 10D shown in FIGS. 2, 5, 6 and 7, can be arranged to achieve virtually any configuration of an array of nozzles desired or imaginable on the bottom of a tub. Each of the nozzle embodiments of the inventive nozzle 10 include a line 14 molded or scribed onto the top center of the main air flow tube 12 in order to facilitate assembly of the nozzles to each other or to connecting tubing and assure that the connecting nozzles are properly aligned with each other and to assure that the planes of the connector plates 11 are parallel or co-planer to each other when attached to the tub. As a matter of convenience, but not essential to the invention, the diameter, either inside or outside, of the flow tube 12 can be sized to standard industry PVC sizes to lessen costs by the ability to use off the shelf tubing and connectors to join adjacent nozzles with connecting tubing. Specific details of the injector tube 13 and the connector plate 11 of the inventive nozzle 10 will now be described with reference to the nozzle embodiment 10A in FIGS. 2, 3, and 4 with the understanding that the described details also apply to the nozzle embodiments of 10B, 10C, and 10D.

Inasmuch as the inventive nozzle is specially configured to be able to be cast or molded in one piece, the air injection tube 13, the main air flow tube 12 and the connector plate 11 are integrally connected to each other. The air injection tube 13 is positioned substantially perpendicular to the plane of the central axis of the main air flow tube 12 and to the plane of the connector plate 11. As seen in FIG. 2, an air injector opening 16 within the injector tube 13 is located in alignment with the central axis of air injector tube but outside of the of the imaginary line of the continuation of the outside diameter of the main air flow tube 12 where it intersects with the injector tube 13. In this manner, the air injector opening 16 intersects with the internal diameter of the flow tube 12 and creates an opening 21 (see FIG. 3) so as to allow flow communication of air from the air flow tube 12 into the air injection hole 16. The intersecting relationship of the air flow tube 12 with the air injector tube 13 is seen in cross section FIG. 3. Here it is seen that the air injector opening 16 within the air injector tube 13 includes a first larger diameter portion 17 and a smaller second diameter portion 18. An annular groove 20 is provided around the first larger diameter portion 17 of the air injector tube 13 a small distance down from the top edge of the air injector tube 13. As explained further herein, the groove 20 is used in conjunction with a sealing plug 15. In a simpler embodiment, the air injector tube 13 and opening 16 can comprise a single external and internal diameter tube that is not shown but can be readily envisioned and is intended to be included within the scope of the present invention. However, the two-diameter air injection tube 13 is preferred and is advantageous for a number of reasons. A check valve 19 is commonly used with each of the nozzles of an air injection arrangement so as to prevent water that is located in the tub from backing up into the airflow channels. The smaller diameter portion 18 is sized to accommodate the commonly used check valve 19. The larger diameter portion 17 is sized so as to create the flow communication opening 21 between the main air flow tube 12 and the air injection tube 13 and yet separate the opening in the smaller diameter portion 18 from the opening in the air flow tube 12. This configuration also allows the nozzle 10 to be molded in one piece while providing the means to accurately drill a hole in the tub at the exact location of the inventive nozzles without the extra effort and jigs required in the prior art.

In the preferred embodiment, the smaller diameter portion 18 of the air injector tube 13 is closed at the bottom end 22 thereof, the advantage of which is more fully explained hereinafter.

The air communication opening or channel 21 permits the flow of air through the main air flow tube 12 to be directed into and through the air injection hole 16 and eventually into the tub. A cap or plug 15 is used to seal the open end of the air injector tube 13 (see FIG. 3). The air injector tube 13 of the inventive nozzle 10 being uniquely positioned to the outside of the outer diameter of the main air flow tube 12 serves a number of advantages. Except for the necessary flow communication opening 21, the integrity of the main flow tube 12 is not compromised. It also provides a means to put the nozzle in place on a tub and then drill a hole 23 simultaneously through the closed bottom 22 of the injector tube 13 and through the tub at the exact location of opening 16 in the nozzle 10.

In practice, the simultaneously drilling of the hole 23 in the injector tube 13 and through the tub (shown in phantom in FIG. 3) can readily be accomplished by various prior art techniques. For example a stepped drill can be used to guide the drilling by using the opening in the smaller diameter portion 18 in the injector tube 13 as the guiding surface.

The stepped drill having two diameters, one diameter comprising the drill portion having the size of the hole to be drilled through the closed end bottom end 22 of the nozzle and through the tub, the other diameter being larger and having the size of the hole in the smaller tube portion 18. The larger diameter portion of the two stepped drill can comprise a circular cylinder without drilling flutes so as to only be guided within the hole of the smaller tube portion 18 and not cause any drilling of the hole in the smaller tube portion 18. Another technique can use a jig having an outer diameter sized to fit within the smaller diameter portion 18 with an opening there through sized to accept and guide a standard drill bit. In this manner, the air injection hole 23 through the closed bottom 22 and through the tub can be drilled at the exact location of the opening in the nozzle. This completely eliminates the prior art method of having to locate the air injection holes in the tub by using the aforedescribed plate on the tub's underside and the jig plate inside the tub. Moreover, the inventive nozzle 10 completely eliminates the need for the prior art air nozzle configuration having an injector tube extending through the tub and the necessarily larger diameter hole in the tub to accommodate the outside diameter of the prior art injection tube, as well as the need to seal between the prior art injection tube and the hole in the tub.

Accordingly, in a preferred embodiment, the bottom 22 of the smaller tube portion 18 of the air injector tube 13 is closed when the nozzle is attached to the underside of the tub which permits the simultaneous drilling of the air injection hole 23 and the hole in the tub at the exact location of the nozzle and perfectly aligned with each other. In another embodiment, the hole 23 is provided in the tube portion 18 before the nozzle is attached to the bottom of the tub which enables the hole 23 to be used to guide a drill bit of the same diameter through the tub and again at the exact location of the nozzle.

FIG. 3 illustrates the check valve 19, shown in phantom, within the smaller diameter portion 18 of the air injector tube 13. FIG. 3 also illustrates in phantom a plug 15 that is inserted into the larger portion 17 of the air injector tube 13. Plug 15 serves to seal the open end of the larger diameter portion 17 of the air injector tube 13 and to fix the position of the check valve 19, while permitting the flow of air from the main flow tube 12 through the air communication channel 21, through the check valve 19, through the air injection hole 23 and into the tub.

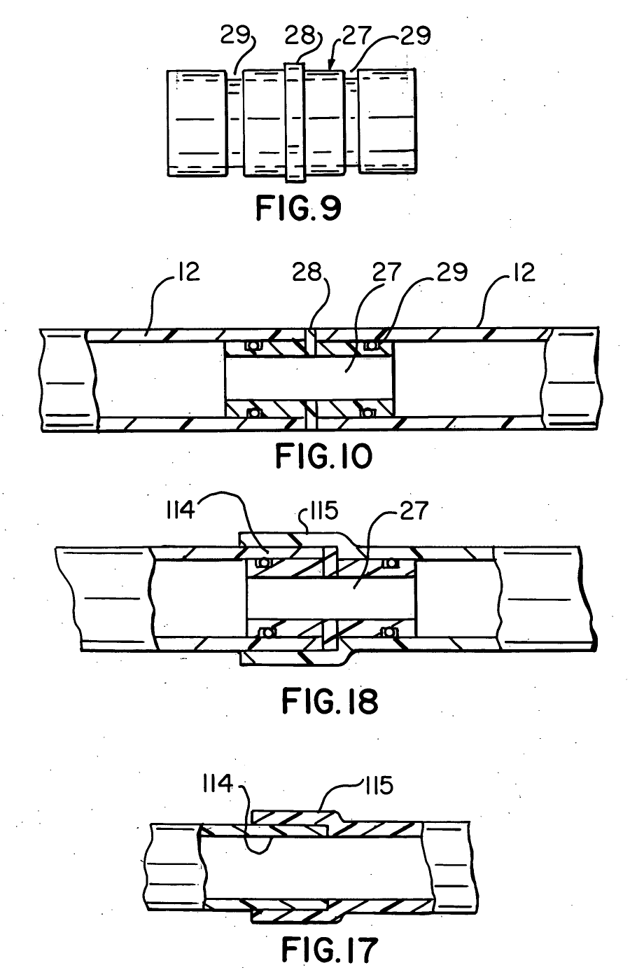

FIG. 8 illustrates an embodiment of the plug 15. Plug 15 includes a top connector portion 31, a cylindrical body portion 32, and flow communication apparatus 33. The top connector portion 31 includes an outer surface 35 that extends beyond the outer diameter of the larger portion 17 of the injector tube 13. The cylindrical body portion 32 includes an outer surface 36 having a diameter slightly smaller than the diameter of the opening 16 within the larger portion 17 of the injector tube 13 so as to easily fit therewithin. A step 37 is thusly provided at the junction of the top connector portion 31 and the cylindrical body portion 32. A blind annular opening 38 is provided within the top connector portion 31 commencing at the surface of the step 37 and extending upward in the direction of the upper surface 39 of the top connector portion 31. The annular opening 38 includes a first outer diameter 40 and a second larger outer diameter 41 with a step 42 therebetween. The inner diameter of annular opening 38 is constant and approximately equals the diameter of the outer diameter of the larger tube portion 17 of the injector tube 13. The portion of the annular opening 38 having the larger outer diameter 41 is located closest to the top end 39 of the top connector portion 31. In accordance with the configuration described, when the plug 15 is placed onto the larger tube portion 17 of the injector tube 13 and is pushed downward, the portion of the annular opening 38 having the smaller outer diameter 40 snaps into place within the annular groove 43 provided around the outer surface of the larger portion 17 of the injector tube 13 so as to securely attach the plug 15 to the injector tube 13.

The junction of the cylindrical body portion 32 and the flow communication apparatus 33 of the plug 15 is configured to form a step 44 therebetween adapted to fit an O ring 45 at the step 44. The cylindrical body portion 32 and the flow communication apparatus 33 are further configured such that when the plug 15 is snapped onto the injector tube 13, the lower end of the flow communication apparatus 33 presses against the top of the check valve 19 and the O ring 45 is sufficiently compressed to seal the opening 16 in the injector tube 13 and prevent the air flowing through the main flow tube 12 from escaping.

In the illustrated plug 15 in FIG. 8, the flow communication apparatus 33 comprises a plurality of pins 46 extending down from the closed bottom end of the cylindrical body 32. The spaces between the pins 46 allows the air to flow from the main flow tube 12 through the flow communication channel or opening 21, through the check valve 19, through the spaces between the pins 46, through the air injection hole or jet 23, and into the tub. Other apparatus such as cross cut grooves or radial grooves in the bottom end of the cylindrical body 32 will also allow the flow of air from the check valve 19 and into the hole in the tub and serve to secure the check valve 19 in place.

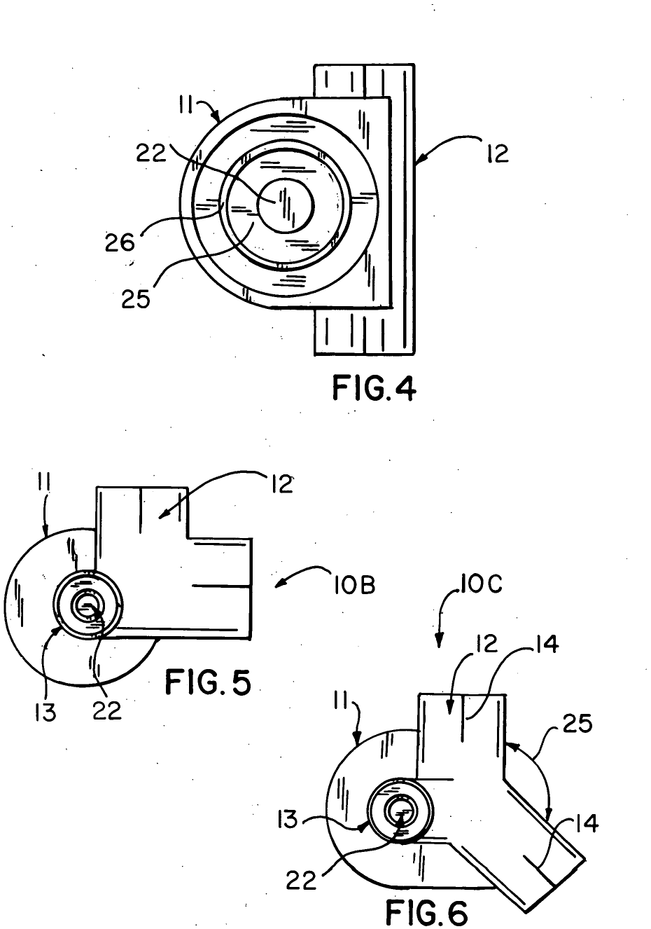

FIG. 4 illustrates one embodiment of the underside of the attaching plate 11. In this embodiment, a plurality of concentric grooves 25, with ridges 26 therebetween are provided at the bottom surface of the connector plate 11. The grooves 25 and ridges 26 allow for direct application of the connector plate 11 to the fiberglass of the tub before the fiberglass is cured such that the connector plate 11 is capable of being inserted into the semi-liquid state of the uncured fiberglass. The ridges 26 will accordingly form corresponding grooves in the uncured fiberglass and the uncured fiberglass will fill the grooves 25. Once the fiberglass is cured, a leak proof and firm connection is effectuated between the tub and the nozzles 10. In this manner, the inventive nozzle 10 saves the time of having to wait for the fiberglass to fully cure as required by the prior art nozzles and the labor and effort to machine the flat surfaces on the cured fiberglass as done in the prior art. If, however, it is desired to attach the nozzles 10 to the tub after the fiberglass has cured, the inventive nozzle 10 does not require the machining of the flat spots as in the prior art. By providing the grooves 25 and the ridges, or the equivalent thereof, the inventive nozzle 10 can be directly applied to the as laid and cured fiberglass. The grooves 25 allow for easy application of a generous bead of silicone rubber in each of the grooves. Prototype testing has shown that the inventive nozzle 10 can accommodate relatively uneven as laid fiberglass when a generous amount of silicon rubber is applied to the connector plate 11, and the nozzle is directly applied to the as laid cured fiberglass on the underside of the tub. The concentric grooves 25 also allow for a visual confirmation that the circular beads of silicon extend completely around and within the grooves 25 so that no leakage gaps exist when this method is used to attach the nozzle 10 to the cured fiberglass of the tub. It is to be noted however, that a connector plate 11 having a flat underside surface as well as configurations other that grooves and ridges are contemplated to be included within the scope of the invention.

FIG. 9 illustrates a configuration of a connection fitting 27 that can be used to sealingly join the flow tube 12 of the nozzles depicted in FIGS. 2, 5, 6 and 7. The connection fitting 27 comprises a short length of tubing having a central flange 28 and an annular groove 29 on either side of the flange 28. In practice the length of tube can be of the order of approximately one to two inches with a spacing of the grooves 29 from the flange 28 approximately of the order of one quarter to one half of an inch. The grooves serve the purpose of fitting an O ring therewithin. The outside diameter of the connection fitting 27 is sized to be slightly smaller than the inside diameter of the flow tube 12 so that it can slip into the flow tube 11 of a nozzle 10 with relative ease, but such that the O ring forms a good seal. A typical connection using the connection fitting 27 is shown in FIG. 10.

While a connecting fitting 27 configured to fit inside the flow tube 12, or connecting tubing as later explained is preferred, it can also be configured to fit the outside of the flow tube 12. In the latter embodiment, the O rings would be located either in grooves on the outside of the flow tube 12 or in grooves on the inside of the connecting fitting 27 and the flange 28 would be located within the inside diameter thereof. If desired, a plurality of O rings can be used on either side of the flange 28.

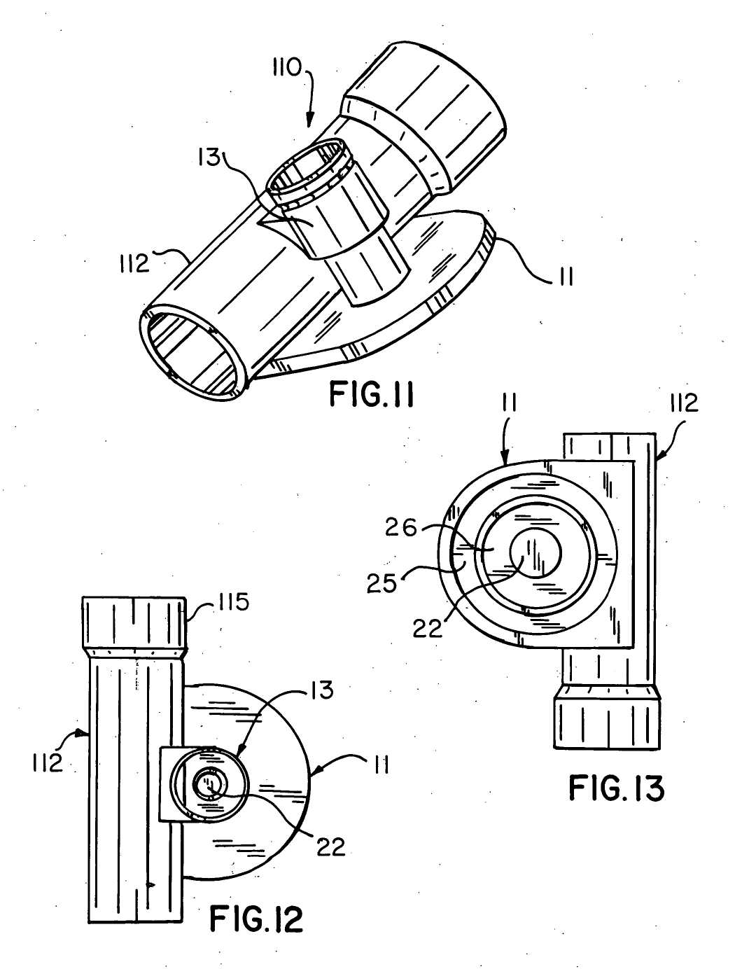

Reference is now made to FIG. 11, which is a perspective view of another embodiment 110A of the nozzle 10 and to FIG. 12 which is a top view of the embodiment of the inventive air nozzle 110A of FIG. 11. As with the previous embodiments of the nozzle 10, the basic elements of the nozzle 110A include a connector or base plate 11, a main airflow tube 112 and an air injection tube. The main air flow tube 112 comprises a circular cylindrical tube having straight end portion 114 and an expanded end portion 115 that respectively extend from opposite sides of the injector tube 13. The internal diameters of the flow tube 112 and the straight end portion 114 are of the same size and appropriately sized to permit the volume of airflow through one or more injector nozzles 110 connected in series or parallel, as is well known in the art. The expanded end portion 115 is provided with an internal diameter that is sized to fit the external diameter of the straight end portion 114 of an adjacent nozzle 110. If PVC material is used to fabricate the nozzle 110, PVC cement can be used to sealing join adjacent nozzles 110 or nozzles 110 and interconnecting PVC tubes. Such PVC cement and sealing of PVC tubes are well known in the art. As a matter of convenience, but not essential to the invention, the size of the main air flow tube 112 and the internal diameter of the expanded end portion 115 can be standard industry sizes to lessen costs by the ability to use off the shelf tubing and connectors and to facilitate joinder of connecting tubing.

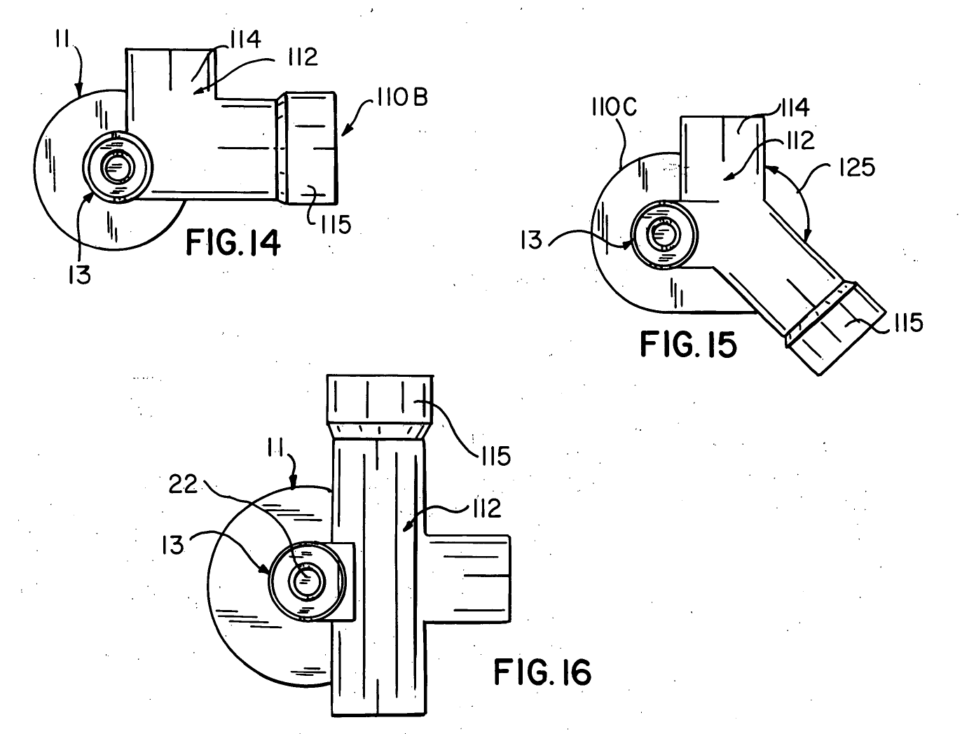

FIG. 14 illustrates an embodiment 110B of the inventive nozzle 110 having the main air flow tube 112 configured to have an “L” shape for such use as a corner nozzle of a row of nozzles 110 in an array of nozzles. Thus, the straight end portion 114 is arranged at a substantially right angle to the expanded end portion 115. By reversing the straight end portion 114 and the expanded end portion 115 from that shown in FIG. 14, yet another embodiment, 110BB is provided. It is to be noted that when a 110B nozzle is joined with another 110B nozzle, a “U” bend is created in a row of nozzles. And, when a 110B nozzle is joined with a 110BB nozzle, an “S” shaped bend is created.

In FIG. 15, the air flow tube 112 of the nozzle embodiment 110C has an angled shape with an included angle 125 of other than ninety degrees between the straight end portion 114 and the expanded end portion 115. For example, the angle 125 can be approximately one hundred and thirty five degrees for such use as a corner of a row of nozzles 110 of greater than ninety degrees. . . . Or, the nozzle 110C can be used as an intermediate nozzle within a row of nozzles to change the direction of the row. Or, two or more angled nozzles 110C can be joined together to result in a more gradual curve than for example the right angled nozzle 110A. Of course, the included angle 125 can be of any desired size. By reversing the straight end portion 114 and the expanded end portion 115 from that shown in FIG. 15, yet another embodiment 110CC is provided. It can be readily envisioned that when a 110e nozzle is joined with another 110C nozzle, a “C” bend is created in a row of nozzles. And, when a 110C nozzle is joined with a 110CC nozzle, a “zigzag” or a skewed “Z” shaped bend is created. A still further embodiment of the 110 comprises that shown in FIG. 16. In this embodiment 110D, the main flow tube 112 has a “T” shaped configuration so as to accommodate three connections.

Accordingly, the invention is not intended to be limited to any particular configuration of the flow tube 112 or the location of the tube portion 114 of the flow tube 112 relative to the expanded portion 115 thereof. The specific details of the injector tube 13 and the connector plate 11 of nozzle embodiments 110A, 110B, 110C, 110D, 110BB, and 110CC are the same as described above with regard to the 10A, 10B 10C, and 10D nozzle embodiments and are, therefore, incorporated this description of the 110 nozzle embodiments by reference.

FIG. 17 illustrates the joinder of a straight end portion 114 of one nozzle 110 to the expanded end portion 115 of an adjacent nozzle 110. As seen, it is a simple joinder where the straight end portion 114 extends within the expanded end portion 115 for an appropriate length so as to effectuate a sealed joint when an appropriate adhesive or PVC cement is used. Inasmuch as both ends of the flow tube 12 of the nozzle embodiment 10 are the same as to each other and the same as to the straight end portion of the 110 nozzle embodiments, FIG. 17 also depicts the joinder of a 10A, B, C, or D nozzle embodiment with a 110A, B, C, D, BB, or CC nozzle embodiment. FIG. 17 also depicts the joinder of a 110 nozzle to connecting tubing where the connection includes a straight end and an expanded end as per the flow tube 112.

FIG. 18 illustrates an alternate method of joining a 10A, B, C, or D nozzle embodiment with a 110A, B, C, D, BB, or CC nozzle embodiment, or to join two 110 nozzle embodiments. In FIG. 18 both the connecting fitting 27 and an adhesive or PVC cement are used. The connecting fitting 27 is inserted into and beyond the internal diameter of the expanded end 115 of the flow tube 112. Then PVC cement or other appropriate adhesive is applied to the outer diameter of either end of the flow tube 12 of the 10 nozzle embodiment or the straight end portion 114 of a 110 nozzle, depending on which embodiments are being joined. Finally, the expanded end 115 is simultaneously fitted over the exposed end of the connector fitting 27 and an end of the flow tube 12 of a 10 nozzle embodiment or the straight tube end 114 of a 110 nozzle embodiment.

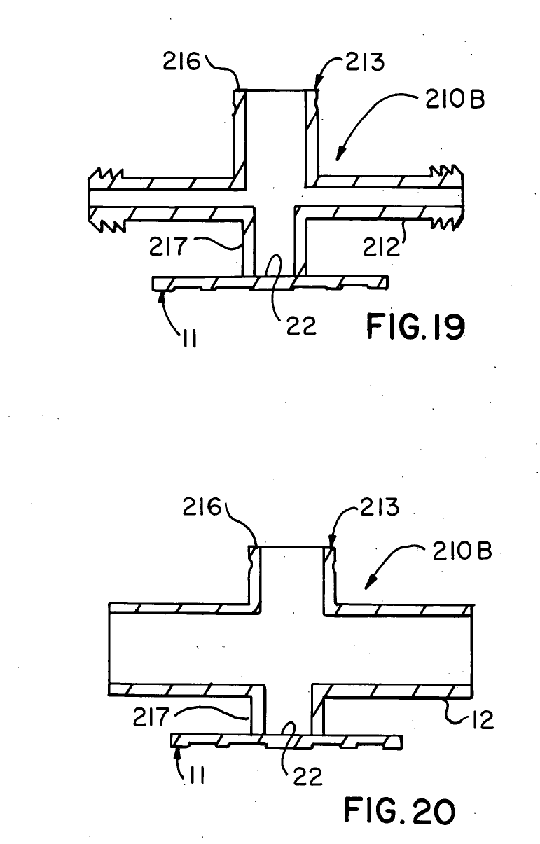

FIGS. 19 and 20 illustrate yet other embodiments 210A and 210B of the inventive nozzle. In these embodiments, the injector tube is not offset relative to the main air flow tube. The embodiment 210A of FIG. 19 depicts a main air flow tube 212 having a diameter smaller than the inventive nozzles of FIGS. 1 and 9. With some tubs, it may be desirable to use small diameter main air flow connecting tubing of the order of ¼ or ⅜ inches in diameter that is relatively flexible. The ends of the main air flow tube 212 can be either plain 214 or barbed 215 used with this embodiment. The barbed ends readily lend themselves to the use of flexible connecting tubing in conjunction with a circular clamp without the use of any type of cement or adhesive. As shown, the air axial axis of the injector tube 214 lies in the same plane as the axial axis of the main air flow tube 214, but again are perpendicular to each other. The air injector tube 213 actually consists of two parts, a cylindrical upper part 216 and a cylindrical lower part 217, each part being molded to the main air flow tube 214, but on opposite sides thereof. An opening 218 is provided where the upper part 216 intersects with the main air flow tube 214. The top end of the injector part 216 is again open as in the previous embodiments. The lower part 217 also has an opening 219 where it intersects with the main air flow tube 214. Where the lower part 216 joins with the connector plate 11, a closed end is provided. Thus, the air injector tube 213 also provides for a check valve 19 to be fitted to the lower part and a cap or plug 15 to be fitted to the upper part 216 as in the previous embodiments.

FIG. 20 depicts an embodiment 210B consistent with the embodiment of FIG. 19 but utilizes the larger tubing 12 of the previous embodiments (FIGS. 1 and 9) where standard sized PVC tubing that is relatively rigid can be used. Here the two part air injector tube 214 is again used, as is the connector plate 11.

The embodiments of FIGS. 19 and 20 further include the various configurations of the main air flow tubes shown in the embodiments of FIGS. 4-7 and 12-16 of the previous embodiments.

In practice, the following method is one that can be used to create a nozzle arrangement to be attached to a tub using the inventive nozzle 10. For purposes of the following installation procedure using the invention described herein, it is assumed that a fabricator has a tub to which he intends to install an air injection system. He will also have an air pump and the associated equipment and tubing for the installation, an appropriate adhesive, fiberglass applying equipment, the proper type of fiberglass and resin, etc, all of which is available in the prior art. The fabricator will also have the layout of where the air injection nozzles are to be placed on the tub. It will also be assumed that the fabricator intends to use the embodiment of the invention shown and described with regard to FIGS. 1-8 and 9.

The fabricator selects the number of and types of air injector nozzles shown in FIGS. 2, 5, 6 and 7 consistent with the planned layout of the air injection arrangement to be applied to the tub. The layout arrangement being arbitrary, as per FIG. 16 for purposes of this description, but in practice being consistent with providing air injection nozzles in an appropriate location on the tub to fitted with a planned air injection arrangement.

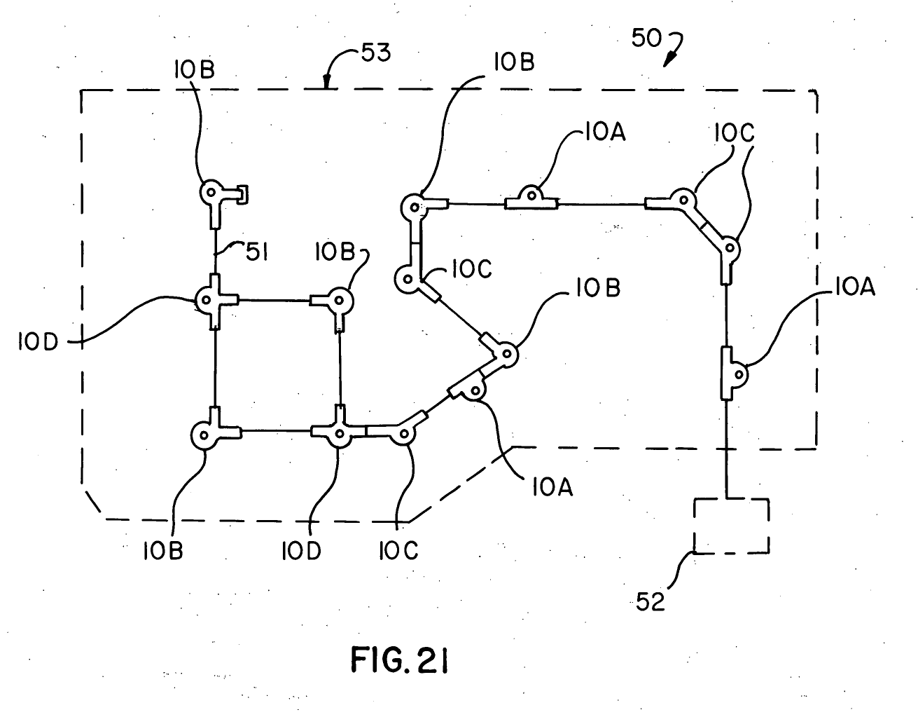

The selected nozzle configurations of nozzle 10 are laid out on a bench or other appropriate surface with each nozzle being positioned at the location according to the planned layout. In all probability some nozzles will be directly connected to each other and some nozzles will be connected using intermediate tubing as illustrated in FIG. 21. Any needed connecting tubing is cut to length and laid out where it will be used.

At this point, the physical components will be laid out and arranged to duplicate the planned arrangement. For purposes of this description, the arbitrary layout 50 such as that shown in FIG. 21 is assumed to be the layout that the fabricator intends to install on the tub. It being understood that the use of the inventive nozzles is not restricted to the layout of FIG. 21. In FIG. 21, the interconnecting tubing is shown as straight lines 51, the air pump 52 is shown in phantom by broken lines and the tub 53 in phantom by broken lines. The connection of the air pump 52 to the tub 53 or other location is as per the prior art. The interconnection tubing 51 is of a size having the same internal diameter of the flow tubes 12 of the inventive nozzles. In accordance with FIG. 19, the nozzles 10A, 10B, 10C, and 10D are placed at the locations shown. The interconnecting tubing 51 is cut in length to fit the distance between the nozzles 10A, 10B, 10C, and 10D. A connecting fitting 27 with the O rings attached, is inserted at each joint between the connecting tubing 51 and the flow tube 12 of each nozzle and between the flow tube 12 of each nozzle where the nozzles are directly connected to each other without any connecting tubing 51 therebetween. The molded or scribed lines 14 provide visual confirmation that the nozzles and the connecting tubing 51 are properly aligned. The connecting fitting 27 and the connections made using the connecting fitting 27 are shown in FIGS. 9 and 10, respectively. The unconnected end of the last nozzle 10B in FIG. 19 is sealingly eternally capped or internally plugged as is known in the prior art. The underside of the tub 53 is now coated with its final layer of fiberglass as per the prior art. In practice, in the prior art, the final layer of fiberglass comprises a mixture of chopped strands of fiberglass and resin (the mixture being in a semi-liquid state) which is blown onto the tub 53. The fitted together arrangement shown in FIG. 19 is then moved from the bench and laid out on still uncured layer of fiberglass on the bottom of the tub 53. Each nozzle within the arrangement 50 is then pushed into the uncured fiberglass making certain that connecting plate 11 of each nozzle is firmly imbedded into the fiberglass such that when the fiberglass is cured, a leak free attachment exists. If necessary, each joint using the connecting piece 27 is checked to make certain that the joints are properly connected as per FIG. 10, and lines 14 are aligned.

After the fiberglass has fully cured and each nozzle connection in the arrangement 50 is fixedly secured within and to the fiberglass, the air injection holes 23 are drilled through the bottom 22 of the air injector tube 13 and through the tub 53, respectively, as described above. A check valve 19 is fitted to the opening in the injector tube of each nozzle and a plug 15 with its attached ring is pushed onto the open end of each injector tube 13 thereby sealing the upper open end of each injector tube 13 as well as the entire arrangement 50. This completes the assembly

The above-described nozzle installation procedure can also be used with or in combination with the nozzle 110 embodiments, but where necessary, the connections being made in accordance with FIG. 17 or 18.

The use of the inventive nozzles is also not restricted to being applied to uncured fiberglass. For example, the arrangement in FIG. 19 can be bench fabricated and laid out on the bottom of a tub, using silicon rubber at the base of each connector plate 11. Then the jet holes 23 and the holes in the tub are simultaneously drilled. The check valves 19 are inserted in the injector tubes and the plugs 15 applied to the open end of the injector tubes. The final layer of fiberglass is then applied over the connected arrangement of nozzles further attaching the nozzle layout to the bottom of the tub.

An alternative to the above use of the inventive nozzles 10 being applied to a first cured layer of fiberglass can comprise temporarily plugging or capping the open end of the injector tubes with a throw-a-way plug or cap. Then, the final layer of fiberglass is applied. After the fiberglass has cured the temporary caps or plugs are removed, the jet holes 23 and the holes through the tub are simultaneously drilled, the check valves 19 installed and the permanent plugs 15 attached.

As shown and described, there exist a number of installation procedures that can be effectively used with the inventive nozzles 10—any one of which substantially reduces the labor and the time involved in the labor as compared to the prior art and provides an improved nozzle arrangement.

It is to be noted that the application of a final layer of fiberglass over a nozzle assembly attached to a first layer of cured or uncured fiberglass has the added advantage of insulating the air being injected into a tub. The final layer of fiberglass provides an insulating coating over the main flow tubes 12, the connector plates 11 and the injector tubes comprising the inventive nozzle. This added insulation acts to advantageously maintain the elevated temperature of the air as it flows through the system and into the tub.

While the invention has been described, disclosed, illustrated and shown in certain terms or certain embodiments or modifications which it has assumed in practice, the scope of the invention is not intended to be nor should it be deemed to be limited thereby and such other modifications or embodiments as may be suggested by the teachings herein are particularly reserved especially as they fall within the breadth and scope of the claims here appended.

1. Nozzle apparatus adapted to be attached to a tub or spa for injection of air into the tub or spa, said nozzle apparatus comprising:
an air flow tube,
a connector plate,
an air injector tube, and
said air injector tube being open at a first end and closed at a second end.

2. The nozzle apparatus of claim 1, wherein said air injector tube has an axial centerline spaced from an axial centerline of said air flow tube.

3. The nozzle apparatus of claim 1 wherein said air injector tube has an axial centerline substantially co-linear with an axial centerline of said air flow tube.

4. The nozzle apparatus of claim 1, wherein said air flow tube, said connector plate, and said air injector tube are integrally connected.

5. The nozzle apparatus of claim 1, including a flow communication channel formed by an intersection of an inner diameter of the air injector tube and an inner diameter of the air flow tube.

6. The nozzle apparatus of claim 1, including said closed end of the air injector tube forming a portion of said connector plate.

7. The nozzle apparatus of claim 1, including a sealing member attached to said open end of said air injector tube.

8. The nozzle apparatus of claim 1, including a hole in said closed end of said air injector tube.

9. The nozzle apparatus of claim 1, including said air injector tube having a first inner diameter and a second inner diameter, said first inner diameter being larger than said second inner diameter.

10. The nozzle apparatus of claim 1 wherein said air injector tube has an axial centerline spaced from an axial centerline of said air flow tube.

11. The nozzle apparatus of claim 1, wherein said air injector tube has an axial centerline substantially co-linear with an axial centerline of said air flow tube.

12. The nozzle apparatus of claim 1, wherein a plane of said connector plate is substantially parallel to an axial centerline of said air flow tube,

13. The nozzle apparatus of claim 1, wherein a plane of the connector plate is substantially perpendicular to an axial centerline of said air injector tube.

14. The nozzle apparatus of claim 1, wherein an axial centerline of said air flow tube is substantially perpendicular to an axial centerline of said air injector tube.

15. The nozzle apparatus of claim 1, wherein a plane of said connector plate is substantially parallel to an axial centerline of said air flow tube,
said plane of the connector plate is substantially perpendicular to an axial centerline of said air injector tube, and
said axial centerline of said air flow tube is substantially perpendicular to said axial centerline of said air injector tube.

16. Nozzle apparatus adapted to be attached to a tub or spa for injection of air into the tub or spa, said nozzle apparatus comprising:
an air flow tube
an integral connector plate,
an integral air injector tube, and
a flow communication channel between the flow tube and the air injector tube,
said flow communication channel being formed by an intersection of an inner diameter of the air injector tube and an inner diameter of the flow tube.

17. The nozzle apparatus of claim 16, wherein said air injector tube is open at a first end and closed at a second end, and having an axial centerline spaced from an axial centerline of said air flow tube.

18. The nozzle apparatus of claim 16, wherein said air injector tube is open at a first end and closed at a second end, and having an axial centerline substantially co-linear with an axial centerline of said air flow tube.

19. The nozzle apparatus of claim 16, including said closed end of the air injector tube forming a portion of said connector plate.

20. The nozzle apparatus of claim 16, including said air injector tube having a first inner diameter and a second inner diameter, said first inner diameter being larger than said second inner diameter.

21. The nozzle apparatus of claim 16, wherein a plane of said connector plate is substantially parallel to an axial centerline of said air flow tube,

22. The nozzle apparatus of claim 16, wherein a plane of the connector plate is substantially perpendicular to an axial centerline of said air injector tube.

23. The nozzle apparatus of claim 16, wherein an axial centerline of said air flow tube is substantially perpendicular to an axial centerline of said air injector tube.

24. The nozzle apparatus of claim 16, wherein a plane of said connector plate is substantially parallel to an axial centerline of said air flow tube,
said plane of the connector plate is substantially perpendicular to an axial centerline of said air injector tube, and
said axial centerline of said air flow tube is substantially perpendicular to said axial centerline of said air injector tube.

25. Nozzle apparatus adapted to be attached to a tub or spa for injection of air into the tub or spa, said nozzle apparatus comprising:
an air flow tube,
an integral connector plate,
an integral air injector tube, and
said air injector tube being open at a first end and closed at a second end.

26. The nozzle apparatus of claim 25 wherein said air injector tube has an axial centerline spaced from an axial centerline of said air flow tube.

27. The nozzle apparatus of claim 25 wherein said air injector tube has an axial centerline substantially co-linear with an axial centerline of said air flow tube.

28. The nozzle apparatus of claim 25, including a flow communication channel formed by an intersection of an inner diameter of the air injector tube and an inner diameter of the air flow tube.

29. The nozzle apparatus of claim 25, including said closed end of the air injector tube forming a portion of said connector plate.

30. The nozzle apparatus of claim 25, including a sealing member attached to said open end of said air injector tube.

31. The nozzle apparatus of claim 25, including a hole in said closed end of said air injector tube.

32. The nozzle apparatus of claim 25, including said air injector tube having a first inner diameter and a second inner diameter, said first inner diameter being larger than said second inner diameter.

33. The nozzle apparatus of claim 25, wherein a plane of said connector plate is substantially parallel to an axial centerline of said air flow tube.

34. The nozzle apparatus of claim 25, wherein a plane of the connector plate is substantially perpendicular to an axial centerline of said air injector tube.

35. The nozzle apparatus of claim 25, wherein an axial centerline of said air flow tube is substantially perpendicular to an axial centerline of said air injector tube.

36. The nozzle apparatus of claim 25, wherein a plane of said connector plate is substantially parallel to an axial centerline of said air flow tube,
said plane of the connector plate is substantially perpendicular to an axial centerline of said air injector tube, and
said axial centerline of said air flow tube is substantially perpendicular to said axial centerline of said air injector tube.

37. Nozzle apparatus adapted to be attached to a tub or spa for injection of air into the tub or spa, said nozzle apparatus comprising:
an air flow tube,
an integral connector plate,
an integral air injector tube, and
said air injector tube being open at a first end and closed at a second end, wherein said air injector tube has an axial centerline spaced from an axial centerline of said air flow tube

38. Nozzle apparatus adapted to be attached to a tub or spa for injection of air into the tub or spa, said nozzle apparatus comprising:
an air flow tube,
an integral connector plate,
an integral air injector tube,
said air injector tube being open at a first end and closed at a second end, and
wherein said air injector tube has an axial centerline substantially co-linear with an axial centerline of said air flow tube.

39. Nozzle apparatus adapted to be attached to a tub or spa for injection of air into the tub or spa, said nozzle apparatus comprising:
an air flow tube,
an integral connector plate,
an integral air injector tube,
said air injector tube being open at a first end and closed at a second end,
said air injector tube having an axial centerline spaced from an axial centerline of said air flow tube, and
including a flow communication channel formed by an intersection of an inner diameter of the air injector tube and an inner diameter of the air flow tube.

40. Nozzle apparatus adapted to be attached to a tub or spa for injection of air into the tub or spa, said nozzle apparatus comprising:
an air flow tube,
an integral connector plate,
an integral air injector tube,
said air injector tube being open at a first end and closed at a second end,
wherein said air injector tube has an axial centerline substantially co-linear with an axial centerline of said air flow tube, and
including a flow communication channel formed by an intersection of an inner diameter of the air injector tube and an inner diameter of the air flow tube.

41. Nozzle apparatus adapted to be attached to a tub or spa for injection of air into the tub or spa, said nozzle apparatus comprising:
an air flow tube,
an integral connector plate,
an integral air injector tube,
said air injector tube being open at a first end and closed at a second end,
said air injector tube having an axial centerline spaced from an axial centerline of said air flow tube, and
including a flow communication channel formed by an intersection of an inner diameter of the air injector tube and an inner diameter of the air flow tube.

42. Nozzle apparatus adapted to be attached to a tub or spa for injection of air into the tub or spa, said nozzle apparatus comprising:
an air flow tube,
an integral connector plate,
an integral air injector tube,
said air injector tube being open at a first end and closed at a second end,
wherein said air injector tube has an axial centerline substantially co-linear with an axial centerline of said air flow tube, and
including a flow communication channel formed by an intersection of an inner diameter of the air injector tube and an inner diameter of the air flow tube.

43. Nozzle apparatus adapted to be attached to a tub or spa for injection of air into the tub or spa, said nozzle apparatus comprising:
an air flow tube,
an integral connector plate,
an integral air injector tube,
said air injector tube being open at a first end and closed at a second end,
said air injector tube having an axial centerline spaced from an axial centerline of said air flow tube,
a flow communication channel formed by an intersection of an inner diameter of the air injector tube and an inner diameter of the air flow tube, and
said closed end of the air injector tube forming a portion of said connector plate.

44. Nozzle apparatus adapted to be attached to a tub or spa for injection of air into the tub or spa, said nozzle apparatus comprising:
an air flow tube,
an integral connector plate,
an integral air injector tube,
said air injector tube being open at a first end and closed at a second end,
wherein said air injector tube has an axial centerline substantially co-linear with an axial centerline of said air flow tube,
including a flow communication channel formed by an intersection of an inner diameter of the air injector tube and an inner diameter of the air flow tube, and
said closed end of the air injector tube forming a portion of said connector plate.

45. Nozzle apparatus adapted to be attached to a tub or spa for injection of air into the tub or spa, said nozzle apparatus comprising:
an air flow tube,
an integral connector plate,
an integral air injector tube,
said air injector tube being open at a first end and closed at a second end,
said air injector tube having an axial centerline spaced from an axial centerline of said air flow tube,
a flow communication channel formed by an intersection of an inner diameter of the air injector tube and an inner diameter of the air flow tube,
said closed end of the air injector tube forming a portion of said connector plate, and
including a hole in said closed end of said air injector tube.

46. Nozzle apparatus adapted to be attached to a tub or spa for injection of air into the tub or spa, said nozzle apparatus comprising:
an air flow tube,
an integral connector plate,
an integral air injector tube,
said air injector tube being open at a first end and closed at a second end,
wherein said air injector tube has an axial centerline substantially co-linear with an axial centerline of said air flow tube,
including a flow communication channel formed by an intersection of an inner diameter of the air injector tube and an inner diameter of the airflow tube,
said closed end of the air injector tube forming a portion of said connector plate,
including a hole in said closed end of said air injector tube.

47. Nozzle apparatus adapted to be attached to a tub or spa for injection of air into the tub or spa, said nozzle apparatus comprising:
an air flow tube,
an integral connector plate,
an integral air injector tube,
said air injector tube being open at a first end and closed at a second end,
said air injector tube having an axial centerline spaced from an axial centerline of said air flow tube,
a flow communication channel formed by an intersection of an inner diameter of the air injector tube and an inner diameter of the air flow tube,
said closed end of the air injector tube forming a portion of said connector plate,
including a hole in said closed end of said air injector tube, and
a sealing member attached to said open end of said air injector tube.

48. Nozzle apparatus adapted to be attached to a tub or spa for injection of air into the tub or spa, said nozzle apparatus comprising:
an air flow tube,
an integral connector plate,
an integral air injector tube,
said air injector tube being open at a first end and closed at a second end,
wherein said air injector tube has an axial centerline substantially co-linear with an axial centerline of said air flow tube,
including a flow communication channel formed by an intersection of an inner diameter of the air injector tube and an inner diameter of the air flow tube,
said closed end of the air injector tube forming a portion of said connector plate,
including a hole in said closed end of said air injector tube, and
sealing member attached to said open end of said air injector tube.

49. Nozzle apparatus adapted to be attached to a tub or spa for injection of air into the tub or spa, said nozzle apparatus comprising:
an air flow tube,
an integral connector plate,
an integral air injector tube, and
said air injector tube having a first open end and a second closed end,
said closed end forming a portion of the connector plate.

50. Nozzle apparatus adapted to be attached to a tub or spa for injection of air into the tub or spa, said nozzle apparatus comprising:
an air flow tube,
an integral connector plate,
an integral air injector tube,
said air injector tube having a first open end and a second closed end,
said closed end forming a portion of the connector plate, wherein said air injector tube has an axial centerline spaced from an axial centerline of said air flow tube.

51. Nozzle apparatus adapted to be attached to a tub or spa for injection of air into the tub or spa, said nozzle apparatus comprising:
an air flow tube,
an integral connector plate,
an integral air injector tube,
said air injector tube having a first open end and a second closed end,
said closed end forming a portion of the connector plate, and
wherein said air injector tube has an axial centerline substantially co-linear with an axial centerline of said air flow tube.

52. Nozzle apparatus adapted to be attached to a tub or spa for injection of air into the tub or spa, said nozzle apparatus comprising:
an air flow tube,
an integral connector plate,
an integral air injector tube,
said air injector tube having a first open end and a second closed end,
said closed end forming a portion of the connector plate,
wherein said air injector tube has an axial centerline spaced from an axial centerline of said air flow tube, and
including a flow communication channel formed by an intersection of an inner diameter of the air injector tube and an inner diameter of the air flow tube.

53. Nozzle apparatus adapted to be attached to a tub or spa for injection of air into the tub or spa, said nozzle apparatus comprising:
an air flow tube,
an integral connector plate,
an integral air injector tube,
said air injector tube having a first open end and a second closed end, said closed end forming a portion of the connector plate,
wherein said air injector tube has an axial centerline substantially co-linear with an axial centerline of said air flow tube, and
including a flow communication channel formed by an intersection of an inner diameter of the air injector tube and an inner diameter of the air flow tube.
